(19) United States
(12) Patent Application Publication
(10) Pub. No.: US 2011/0276625 A1
(43) Pub. Date: Nov. 10, 2011

(54) METHOD AND SYSTEM FOR HOST INDEPENDENT KEYBOARD, VIDEO, AND MOUSE (KVM) REDIRECTION

(76) Inventor: Hemal Shah, Trabuco Canyon, CA (US)

(21) Appl. No.: 13/077,193

(22) Filed: Mar. 31, 2011

Related U.S. Application Data
(60) Provisional application No. 61/332,181, filed on May 6, 2010.

(51) Int. Cl. G06F 15/16

(52) U.S. Cl. 709/203

(57) ABSTRACT

A management controller in a network device may provide and/or support host-independent keyboard, video, and mouse (KVM) redirection operations in the network device. The management controller may be integrated into a network controller in the network device. The management controller may enable routing of KVM redirection related interactions between the network device and remote KVM peers, with KVM redirection related functions and/or operations being performed and/or provided by other components in the network device. The management controller may also implement a KVM protocol stack utilized in providing peer-to-peer KVM redirection connectivity and/or communications, and/or invoking KVM services in the network device. The management controller may also directly provide and/or perform at least a portion of the KVM services. The management controller may utilize during host-independent KVM redirection, keyboard driver, mouse driver, and/or graphics driver in a basic input/output system (BIOS) of the network device.

### CLAIM OF PRIORITY

This patent application makes reference to, claims priority to and claims benefit from U.S. Provisional Application Ser. No. 61/332,181 (Attorney Docket No. 23031US01), which was filed on May 6, 2010.

The above stated application is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to networking. More specifically, certain embodiments of the invention relate to a method and system for host independent keyboard, video, and mouse (KVM) redirection.

### BACKGROUND OF THE INVENTION

Network devices may communicate using wireless and/or wired connection, and be utilized to receive inputs, store and process data, and provide outputs for various applications. Network devices may comprise, for example, person computers (PCs), laptops, servers, workstations, smart phones or other similar handheld mobile devices. A network device may comprise a network interface controller (NIC), which may be coupled internally (i.e. integrated into) or externally to the computer system. The NIC may be utilized in network access operations, to enable sending and/or receiving data, in the form of network packets, via wired and/or wireless connections.

Information Technology (IT) management may require performing remote management operations of remote systems to perform inventory and/or to determine whether remote systems are up-to-date. For example, management devices and/or consoles may perform such operations as discovering and/or navigating management resources in a network, manipulating and/or administrating management resources, requesting and/or controlling subscribing and/or unsubscribing operations, and executing and/or specific management methods and/or procedures. Management devices and/or consoles may communicate with devices in a network to ensure availability of remote systems, to validate that systems may be up-to-date, and/or to perform any security patch updates that may be necessary.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for host independent keyboard, video, and mouse (KVM) redirection, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary communication system for providing keyboard, video, and mouse (KVM) redirection between a remote device and a local device, which may be utilized in accordance with an embodiment of the invention.

FIG. 2 is a block diagram illustrating an exemplary network device that supports host-independent keyboard, video, and mouse (KVM) redirection via a management controller, in accordance with an embodiment of the invention.

FIG. 3A is a block diagram illustrating exemplary host-independent keyboard, video, and mouse (KVM) redirection via a management controller using system BIOS, with the BIOS providing both KVM services and KVM stack, in accordance with an embodiment of the invention.

FIG. 3B is a block diagram illustrating exemplary host-independent keyboard, video, and mouse (KVM) redirection via a management controller using system BIOS, with the BIOS providing only KVM services, in accordance with an embodiment of the invention.

FIG. 3C is a block diagram illustrating exemplary host-independent keyboard, video, and mouse (KVM) redirection via a management controller using system BIOS, with the management controller providing both KVM services and KVM stack, in accordance with an embodiment of the invention.

FIG. 3D is a block diagram illustrating exemplary host-independent keyboard, video, and mouse (KVM) redirection via a management controller using system BIOS, with the management controller providing both KVM services and KVM stack and interacting directly with graphic controllers, in accordance with an embodiment of the invention.

FIG. 4 is a flow chart that illustrates exemplary steps for host independent keyboard, video, and mouse (KVM) redirection, in accordance with an embodiment of the invention.

### DETAILED DESCRIPTION OF THE INVENTION

Certain embodiments of the invention may be found in a method and system for host independent keyboard, video, and mouse (KVM) redirection. In various embodiments of the invention, a management controller in a network device may provide and/or support host-independent keyboard, video, and mouse (KVM) redirection operations in the network device. In this regard, the management controller may support and/or perform KVM redirection independent of availability of host environment in the network devices, which may comprise operating system (OS), a basic input/output system (BIOS), virtualization related components such as virtual machines (VMs) and/or virtual machine monitor or hypervisor (VMM), and/or graphics components in the network device. The management controller may be integrated into a network controller in the network device, or it may be implemented as a dedicated component. The management controller may be operable to route, during host-independent KVM redirection operations, KVM redirection related interactions and/or messaging between the network device and remote KVM redirection peers. The handling of KVM redirection related functions and/or operations may be performed and/or provided by other components in the network device, such as via the BIOS and/or a graphics controller. In this regard, during host-independent KVM redirection, the management controller may utilize keyboard driver, mouse driver, and/or graphics driver in the BIOS of the network device.

One or more KVM redirection protocol stacks may be implemented in the network device to support KVM redirection. In this regard, KVM redirection protocol stacks may be utilized in supporting peer-to-peer KVM redirection connectivity and/or communications, and/or in invoking KVM redirection services in the network device. The KVM redirection protocol stacks may be implemented in the BIOS, and the BIOS may also provide and/or perform at least a portion of the corresponding KVM redirection services. The management controller may implement at least a portion of the KVM redirection protocol stacks, and/or the management controller may also directly provide and/or perform at least a portion of the KVM redirection services. During management controller supported host-independent KVM redirection, the management controller may exchange KVM redirection related messages and/or data with other components of the network device, such as the BIOS and/or the graphics controller. In this regard, the KVM redirection related messages and/or data may be communicated over existing internal system communication interfaces available in the network device, which may comprise Peripheral Component Interconnect Express (PCI-E) and/or System Management Bus (SMBus) based system buses or interconnects.

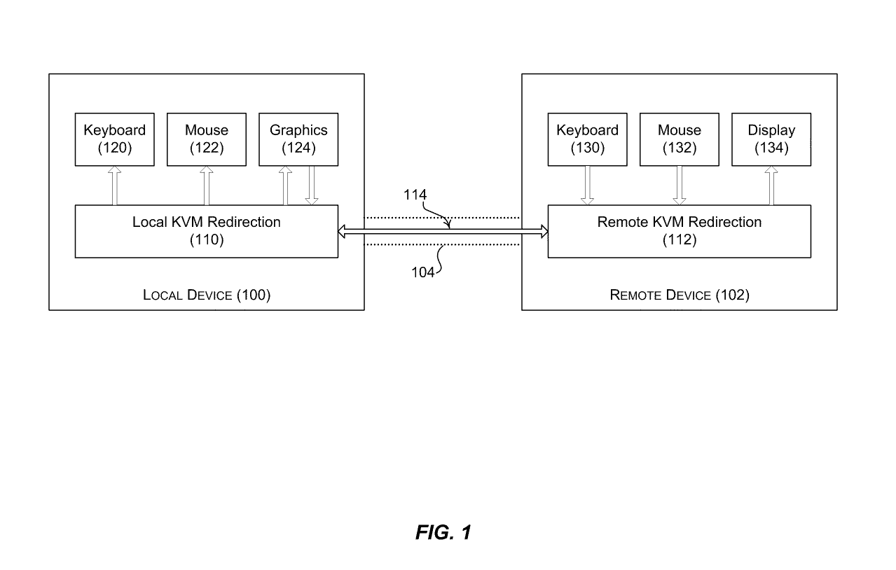

FIG. 1 is a block diagram that illustrates an exemplary communication system for providing keyboard, video, and mouse (KVM) redirection between a remote device and a local device, which may be utilized in accordance with an embodiment of the invention. Referring to FIG. 1, there is shown a local device 100 and a remote device 102, which may communicate via a network link 104.

The local device 100 may comprise suitable logic, circuitry, interfaces, and/or code for receiving, transmitting, and/or processing of network traffic, to facilitate network access operations in conjunction with applications or tasks performed in the local device 100 and/or based on user interactions with the local device 100. In this regard, the local device 100 may comprise a personal computer (PC), a server, a mainframe, a network router or switch, a network printer, and/or a dedicated network storage device. In some embodiments of the invention, the local device 100 may be operable to support and/or participate in management operations, based on one or more management standards and/or protocols. Exemplary management standards and/or protocols, may comprise Distributed Management Task Force (DMTF) based Web Service Management (WS-Management) and/or Alert Standard Format (ASF) related protocols. In this regard, the local device 100 may comprise one or more dedicated components, such as management controller, for use in conjunction with management related operations.

The remote device 102 may comprise suitable logic, circuitry, interfaces, and/or code for receiving, transmitting, and/or processing of network traffic, to facilitate network access operations in conjunction with applications or tasks performed in the remote device 102 and/or based on user interactions with the remote device 102. In some embodiments of the invention, the remote device 102 may be operable to support and/or participate in management operations, based on one or more management standards and/or protocols. For example, the remote device 102 may be utilized by Information Technology (IT) operators and/or network administrators to manage and/or control various devices, such as the local device 100 for example. Exemplary management operations may comprise discovering and/or navigating resources in a managed network, manipulating and/or administrating managed resources, ensuring availability of systems and/or devices, validating that systems and/or devices (or applications therein) may be up-to-date, requesting and/or controlling subscribing and/or unsubscribing operations, performing security patch updates. In this regard, the remote device 102 may comprise one or more dedicated components which may be utilized to support and/or perform management operations. To facilitate performing such management operations, the remote device 102 may utilize network connections, such as the network link 104, to communicate with managed devices, such as the local device 100.

In this regard, network link 104 may comprise a medium, and/or corresponding network interfaces within the remote device 102 and the local device 100, for exchanging data and/or messages between the remote device 102 and the local device 100. The network link 104 may comprise, for example, an Ethernet (IEEE 802.3) link, which may enable the remote device 102 and/or the local device 100 to exchange data and/or messages via Ethernet packets transmitted and/or received via one or more wired and/or wireless connections. In an exemplary aspect of the invention, messages and/or data pertaining to specific operations, such as management operation, may be exchanged using network packets communicated via the network link 104. For example, during management operations, the network link 104 may be utilized by the remote device 102 and network device 102 to exchange WS-Management protocol based messaging and/or ASF protocol messaging.

In operation, the local device 100 and the remote device 102 may communicate via the network link 104. In this regard, the local device 100 and the remote device 102 may exchange messages and/or data pertaining to applications and/or tasks which may be performed collaboratively by the devices. For example, the local device 100 and the remote device 102 may exchange messages and/or data pertaining to management operations, performed in the context of managing local device 100 via the remote device 102. In this regard, the remote device 102 may be utilized by a network administrator to manage a plurality of network devices, such as the local device 100. For example, the network link 104 may support exchanging management related messaging based on one or more standards-based management protocols, to enable performing management operations between the remote device 102 and the local device 100. For example, local device 100 and/or the remote device 102 may support use of ASF and/or WS-management based messaging, transmitted and/or received via Ethernet packets communicated over the network link 104, during management operations between the remote device 102 and the local device 100. The Alert Standard Format (ASF) protocol may be used in first generation out-of-band management systems. In this regard, the ASF functionality may be implemented using User Datagram Protocol (UDP) based stack, to facilitate communication between management devices and network devices. Accordingly, devices supporting and/or using ASF functionality and/or interfaces may perform and/or participate in management operations using ASF messages, which may be transported via UDP based connections.

The Web Service Management (WS-Management) protocol has been developed as a next generation management protocol. The WS-Management protocol is based on the Simple Object Access Protocol (SOAP), which utilizes XML based messaging and HTTP(S) sessions, and may utilize TCP based transport connectivity for communications between management devices and network devices. Use of SOAP over HTTP(S) may require supporting HTTP/TLS/TCP stack implementation in the management/network devices, which may, however, ensure improved security, reliability, and OS-independent operations. Furthermore, the DMTF has defined a management data model called Common Information Model (CIM), which may be utilized in conjunction with the WS-Management protocol during management operations. The CIM based data model may provide object oriented representation of management data, managed resources, and/or management relationships, which may be accessed and/or configured using WS-Management protocol based messaging. Accordingly, devices supporting and/or using WS-Management, and/or CIM based functionality and/or interfaces, may perform and/or participate in out-of-band management operations using WS-Management based messaging, which may be transported via TCP connections. For example, the remote device 102 may utilize WS-Management based messaging to during management of the local device 100 in instances where the local device 100 may comprise Intelligent Platform Management Interface (IPMI) and/or ASF based internal communications within the components of the local device 100.

In an exemplary aspect of the invention, the local device 100 and the remote device 102 may be configured to support keyboard, video, and mouse (KVM) redirection. In this regard, KVM redirection may enable simulating remote use and/or operations of certain components and/or peripheral devices, such as keyboard, mouse, and/or display, which may typically be utilized in conjunction with such devices as personal computers or servers. For example, use of KVM redirection may enable a user of the remote device 102 to utilize keyboard 130 and/or mouse 132 of the remote device 102 to generate keyboard and/or mouse inputs for the local device 100, and/or to view graphics associated with the local device 100 via display 134 of the remote device 102. In other words, KVM redirection may enable users of the remote device 102 to the use the keyboard 130, mouse 132, and/or display 134 of the remote device 102 to interact with the local device 100 as if these peripheral devices were connected “directly” to the local device 100. During KVM redirection, KVM related data and/or messages may be exchanged between the KVM peers, the remote and local peers, based on a KVM redirection protocol, such as the Virtual Network Computing (VNC) protocol for example. In this regard, KVM redirection protocols may define mechanisms, and/or message or data structures that may be used for and/or may enable communication of KVM redirection related messaging. For example, the KVM redirection protocol may define messaging structures and/or sequences for communicating keyboard and/or mouse inputs of the remote peer, such as keyboard 130 and/or mouse 132 of the remote device 102, to be used as local keyboard and/or mouse inputs at the local peer, the local device 100. The KVM redirection protocol may also define messaging structures and/or sequences for communication of graphics related data from the local peer to the remote peer to enable generating and displaying copies of screen therein, such as via the display 134 of the remote device 102 for example. KVM redirection may be utilized in conjunction with other remote access operations, such as during remote management operations. In this regard, KVM redirection may be utilized during management of the local device 100 via the remote device 102 to enable monitoring, controlling, repairing, and/or diagnosing the local device 100, and/or components thereof remotely.

To facilitate and/or support KVM redirection operations, the local device 100 and the 102 device 102 may comprise local-side KVM redirection component 110 and remote-side KVM redirection component 112, respectively. In this regard, each of the local-side KVM redirection component 110 and remote-side KVM redirection component 112 may comprise suitable logic, circuitry, interfaces, and/or code for implementing, supporting, and/or performing KVM related operations, functions, and/or interactions based thereon and/or related thereto. In this regard, the local-side KVM redirection component 110 and remote-side KVM redirection component 112 may be operable to support use of KVM redirection connection 114, which may be based on one or more KVM redirection protocols supported by both peers, and which may be utilized in exchanging KVM related messages and/or data between the local-side KVM redirection component 110 and remote-side KVM redirection component 112 during KVM redirection. The KVM redirection connection 114 may be established via the network link 104 between the local device 100 and the remote device 104.

Furthermore, each of the local-side KVM redirection component 110 and remote-side KVM redirection component 112 may be operable to implement and/or support one or more KVM redirection protocol and/or related services, and/or to interact with certain components within the local device 100 and the 102 device 102, respectively, based on supported KVM redirection protocols and/or related services. In this regard, the remote-side KVM redirection component 112 may be operable to interact with the keyboard 130, the mouse 132, and/or the display 134 of the remote device 102, to enable receiving keyboard and/or mouse inputs from the keyboard 130 and/or the mouse 132, for use as local keyboard and/or mouse inputs at the local device 102, and/or to enable displaying screen copies associated with the local device 100, via the display 134 based on graphics related data received from the local device 100.

The local-side KVM redirection component 110 may be operable to utilize keyboard and/or mouse input information, received from the remote-side KVM redirection component 112, via the local keyboard function 120 and/or the local mouse function 122. In this regard, the local keyboard function 120 and/or the local mouse function 122 may correspond to, for example, keyboard and/or mouse drivers utilized within the local device 100 in interacting with physical keyboard and/or mouse locally at the local device 102. In other words, the local keyboard function 120 and/or the local mouse function 122 may utilize received keyboard and/or mouse inputs in a manner that may be substantially the same as locally generated keyboard and/or mouse input data. The local-side KVM redirection component 110 may be operable to utilize the local graphics function 124 for obtaining graphics related information which may be communicated to the remote-side KVM redirection component 112, for display via the display 134 of the remote device 102 for example. In this regard, the local graphics function 124 may correspond to, for example, graphics controller which may be utilized within the local device 100 in interacting with physical display utilized locally at the local device 100.

In various exemplary embodiments of the invention, the local device 100 may support host-independent KVM redirection. In this regard, the “host” may correspond to hardware, software, and/or firmware, in network devices which may be used to perform and/or control tasks, applications, and/or services available in these devices. For example, in the local device 100, the “host” may correspond to particular hardware and/or software components of the local device 100, which may comprise, for example, one or more processors, such as a central processing unit (CPU), storage components, such as memory devices, an operating system (OS) and/or virtual machines (VMs) running in the local device 100, and/or applications or processes performed or executed by the OS and/or the VMs. Accordingly, to facilitate host-independent KVM redirection, components that may be available even when the host environment is not available may be utilized in providing at least portion of the KVM redirection related operations. For example, in instances where the local device 100 may participate in management operations, dedicated management components in the local device 100, such as a management controller for example, may be utilized to support and/or enable host-independent KVM redirection. In this regard, it may be desirable to utilize management components and/or functions to support KVM redirection because KVM operations may be performed as part of management related interactions, and/or because such management components may remain available even in instances where other components of the local device 100, such as any OS or VM running therein, may be unavailable, such as prior to starting and/or loading of the OS (pre-OS), or after any crash of the OS (post-OS).

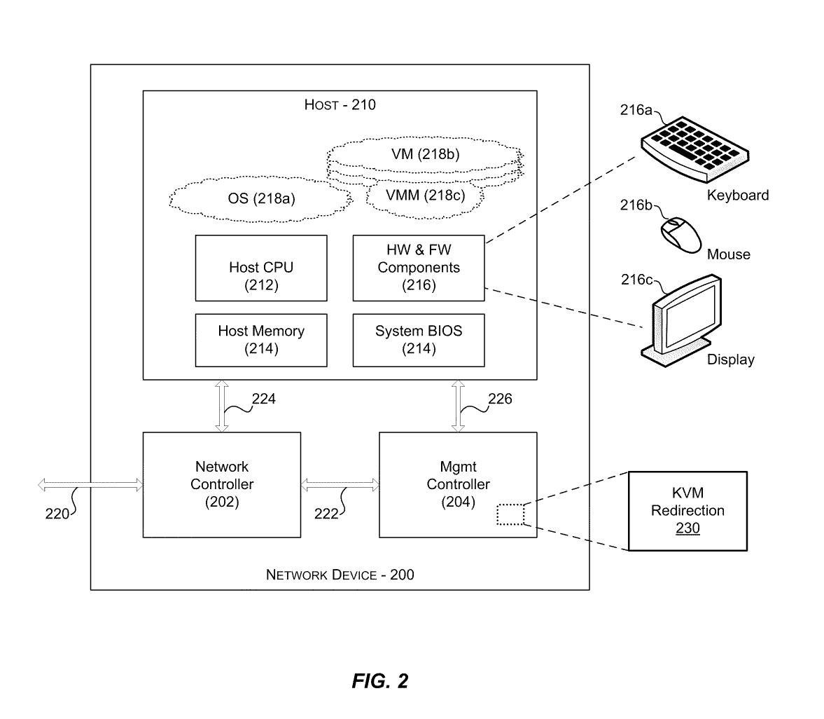

FIG. 2 is a block diagram illustrating an exemplary network device that supports host-independent keyboard, video, and mouse (KVM) redirection via a management controller, in accordance with an embodiment of the invention. Referring to FIG. 2, there is shown a network device 200.

The network device 200 may comprise suitable logic, circuitry, interfaces, and/or code that may enable reception, transmission, and/or processing of network traffic. The network device 200 may also be operable to participate in various networking related operations, such as management operations for example. The network device 200 may comprise, for example, a network controller 202, a management controller 204, and a host 210. Exemplary network devices may comprise personal computers (PCs), laptops, servers, mainframes, network routers, bridges, and/or switches, and/or other similar communication devices. The network device 200 may correspond to, for example, the local device 100 of FIG. 1.

The network controller 202 may comprise suitable logic, circuitry, interfaces, and/or code that may handle network traffic, such as network traffic 220, which may be received and/or transmitted by the network device 200. In this regard, the network controller 202 may be operable to communicate network traffic 220 via one or more wired and/or wireless connections. The network controller 202 may comprise a network interface controller (NIC).

The management controller 204 may comprise suitable logic, circuitry, interfaces, and/or code that may be operable to perform and/or provide management operations and/or services in the network device 200, which may be based on one or more management protocols such as the WS-Management for example, and/or to support corresponding interactions and/or messaging with management entities. In this regard, the management controller 204 may be operable to process management-network traffic 222, which may be received and/or transmitted via the network controller 202 for example, as part of the network traffic 220 during management related exchanges with remote entities, such as remote device 102 of FIG. 1. To facilitate and/or support management operations, the management controller 204 may be operable to interact with other components and/or subsystems in the network device 200, such as the host 210, and/or components thereof, via host-management traffic 226 for example, to provide configuration and/or control data, and/or to obtain feedback and/or status information as needed to perform supported management operations and/or services. While the management controller 204 is shown as a separate component in the network device 200, the invention need not be so limited. Accordingly, the management controller 204 may be integrated into a network controller 202, with hardware and/or software (or firmware) components thereof being utilized in performing various operations descried with respect to the management controller 204.

In an exemplary aspect of the invention, the management controller 204 may be operable to provide and/or support host-independent KVM redirection. In this regard, the management controller 204 may comprise a KVM redirection component 230, which may comprise suitable logic, circuitry, interfaces, and/or code that may be operable to perform and/or support at least a portion of KVM redirection related operations in the network device 200. The KVM redirection component 230 may be implemented as a dedicated physical component in the management controller 204. In this regard, the KVM redirection component 230 may be a fixed component, and accordingly, it may be integrated directly into the management controller 204, and/or it may be removable, such as a card-like extension, which may be coupled to and/or inserted into the management controller via PCI-E, Universal Serial Bus (USB), Firewire (IEEE1394), and/or other bus interface based connectors, ports, or slots for example. The KVM redirection component 230, or portions thereof, may also be implemented as software (or firmware) component, and operations described with respect to the KVM redirection component 230 may be performed by existing physical components of the management controller 204, such as existing processing resources in the management controller 204. In this regard, KVM redirection related operations services described with respect with the KVM redirection component 230 may be programmed into the management controller 204, and/or may be updated and/or modified thereafter, based on direct interactions with the network device 200 and/or based on updates received from remote location, using network access of the network device 200 for example.

The host 210 may correspond to components and/or subsystems in the network device 200, which may be utilized for running and/or executing processes, tasks, and/or applications that may be provided by and/or performed in the network device 200. In this regard, the host 210 may comprise one or more host processors 212, one or more memories 214, a Basic Input/Output System (BIOS) 214, and a plurality of hardware and/or firmware components 216. The host 210 may also comprise an operating system (OS) 218a, and/or any applications and/or processes running therein. The OS 218a may be run via the host processor 212, for example. Furthermore, in instances when the network device 200 is implemented as virtualization based platform, the host 210 may comprise one or more virtual machines (VMs) 218b and/or a virtual machine monitor or hypervisor (VMM) 218c.

The BIOS 214 may comprise suitable logic, circuitry, interfaces and/or code for initializing, configuring, and/or controlling certain components, such as input/output (I/O) components, in the network device 200. The BIOS 214 may be utilized during power up sequences, for example. In this regard, the BIOS 214 may comprise code stored in a read-only memory (ROM), for example, which may be executed when network device 200 is powered up, and used to identify, test, and initialize (“boot up”) certain components of the network device 200. Therefore, prior to completion of system boot up, the network device 200 may have limited functionality. During boot up sequences, the BIOS 214 may initialize and/or start up the OS 218a, the VMs 218b, and/or the VMM 218c for example. Consequently, a host environment, corresponding to the host 210, which may typically run on the network device 200 during normal functionality, may not be running prior to completion of boot up, when the OS 218a, the VMs 218b, and/or the VMM 218c are not yet available (i.e. pre-OS). The host environment may also be unavailable in certain scenarios after the completion of system boot up, when the OS 218a, the VMs 218b, and/or the VMM 218c become unavailable (i.e. post-OS), such as in instances where errors may occur, causing the OS 218a, the VMs 218b, and/or the VMM 218c to crash, hang, become unresponsive, and/or shutdown. The host 210, and/or components therein such as the host processor host processor 212, the OS 218a, and/or the VMs 218b, may also become unavailable due to transitions to certain states, such as transitions to low power states, which may comprise “hibernate” or “sleep” states.

The hardware and/or firmware components 216 may comprise, for example, one or more hard disk drives, one or more NVRAM elements, chipsets, sensors, video or graphics controllers (cards), audio controllers (cards). The hardware and/or firmware components 216 may also comprise peripheral devices, such as keyboard 216a, mouse 216b, and/or display 216c. Furthermore, the hardware and/or firmware components 216 and/or the BIOS 214 may comprise specific software components which may be used in operating and/or interacting with certain hardware components. For example, BIOS 214 may comprise device drivers which may be utilized in operating and/or interacting with peripheral I/O devices, such as keyboard 216a, mouse 216b, and/or display 216c.

In an exemplary aspect of the invention, at least some of BIOS 214 and/or the hardware and/or firmware components 216 may run and/or be available independent from operations and/or availability of the host 210. In this regard, one or more functions of the BIOS 214 and/or at least of the hardware and/or firmware components 216 may remain available even where the host 210 as a whole, and/or particular components thereof, such as the OS 218a, may be unavailable.

The network traffic 220 may comprise network packets received and/or transmitted by the network device 200 via one or more network connections, which may comprise, for example, wired connections, such as Ethernet (IEEE 802.3) based connections, and/or wireless based connection, such as WLAN (IEEE 802.11) based connections. In this regard, data carried via the network traffic 220 may correspond to the host-network traffic 224 and/or management-network traffic 222. The host-network traffic 224 may comprise data and/or messages transmitted and/or received by the host 210, and/or applications or processes running therein. For example, the host-network traffic 224 may comprise data transmitted and/or received by web browsing applications that may be running in the network device 104. The management-network traffic 222 may comprise data and/or messages transmitted and/or received by the network device 200 during management operations, which may be handed by the management controller 204. For example, the management-network traffic 222 may comprise WS-Management based messages communicated to and/or from the network device 200, to support WS-Management services and/or applications performed therein.

In operation, the network controller 202 may receive, transmit, and/or process the network traffic 220. The management controller 204 may be operable to perform management operations in the network device 200, and/or to receive, transmit, and/or process the management-network traffic 222. In this regard, the management controller 204 may perform, control, and/or support management services and/or operations provided by and/or performed in the network device 200, and/or may perform necessary interactions with remote management entities, such as the remote device 102 of FIG. 1, for example, during these management operations and/or services. The management controller 204 may support in-band and/or out-of-band management operations. During management related operations, the management controller 204 may interact with host 210, and/or components thereof, to enable performing necessary configuration and/or control operations based on received management messages. The management controller 204 may also interact with the host 210, and/or components thereof to query, log, and/or store data pertaining to events and/or errors occurring therein, and/or to determine conditions thereof. The interactions between the management controller 204 and the host 210, and/or components thereof, may be performed indirectly, via the network controller 202 for example. Alternatively, the management controller 204 may be operable to interact directly with the host 210, and/or components thereof, over existing and/or available internal communication subsystems, which may comprise a System Management Bus (SMBus) and/or Peripheral Component Interconnect Express (PCI-E) based buses and/or interconnects within the network device 200.

In an exemplary aspect of the invention, the network device 200 may support keyboard, video, and mouse (KVM) redirection, substantially as described with respect to FIG. 1. In this regard, KVM redirection may enable receiving keyboard and/or mouse inputs from remote devices, via KVM redirection based messages, and/or utilizing these received inputs within the network device 200 as if they had been local inputs from keyboard 216a and/or mouse 216b. KVM redirection may also comprise communicating graphics related information, which would have been utilized locally via display 216c for example, to these remote devices for use thereby, via KVM redirection based messages. In this regard, the KVM redirection related communication between the network device 200 and remote peers may be performed based on one or more mutually supported KVM redirection protocols.

KVM redirection may be provided and/or supported by, and/or may require availability of the host 210, or certain component thereof. For example, KVM redirection protocol stacks, and/or related functions and/or services, may reside in and/or may be provided by the OS 218a, one or more of the VMs 218b, and/or the VMM 218c. Accordingly, KVM redirection may be unavailable in certain scenarios, such as when the host 210, or certain components thereof, may not be available. For example, KVM redirection may become unavailable in some low power states, and/or when the OS 218a, one or more of the VMs 218b, and/or the VMM 218c may be unavailable. In this regard, KVM redirection may not be available in pre-OS scenarios, such as during boot up sequences, and/or in post-OS scenarios, such as when the OS 218a, one or more of the VMs 218b, or the VMM 218c may be in hung state and/or crashes.

Accordingly in various embodiments of the invention, the network device 200 may support host-impendent KVM redirection. In this regard, the network device 200 may be configured to implement host-independent KVM redirection architecture, to enable providing KVM redirection, such as during Pre-OS and/or Post-OS scenarios. For example, the management controller 204 may, via the KVM redirection component 230, provide at least a portion of KVM redirection in the network device 200, independent of operations and/or availability of the host 210, and/or of various components thereof, such as OS 218a, the VMs 218b, and/or the VMM 218c. In this regard, to provide host-independent KVM redirection via the management controller 204, the management controller 204 may implement and/or perform, via the KVM redirection component 230 for example, at least a portion of the KVM redirection stack and/or related services pertaining to at least one of KVM redirection protocols supported by the network device 200. Accordingly, the management controller 204 may be operable to expose, via the KVM redirection component 230, keyboard, mouse, and/or graphics functions that may be utilized by remote devices to connect to or communicate with network device 200, and/or to perform KVM redirection therein even when the host 210 becomes unavailable, such as in pre-OS and/or post-OS scenarios.

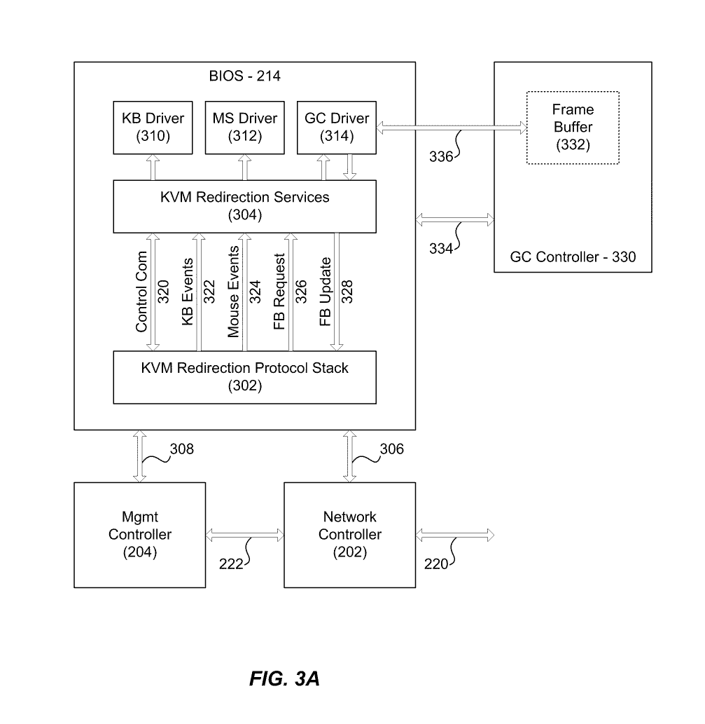

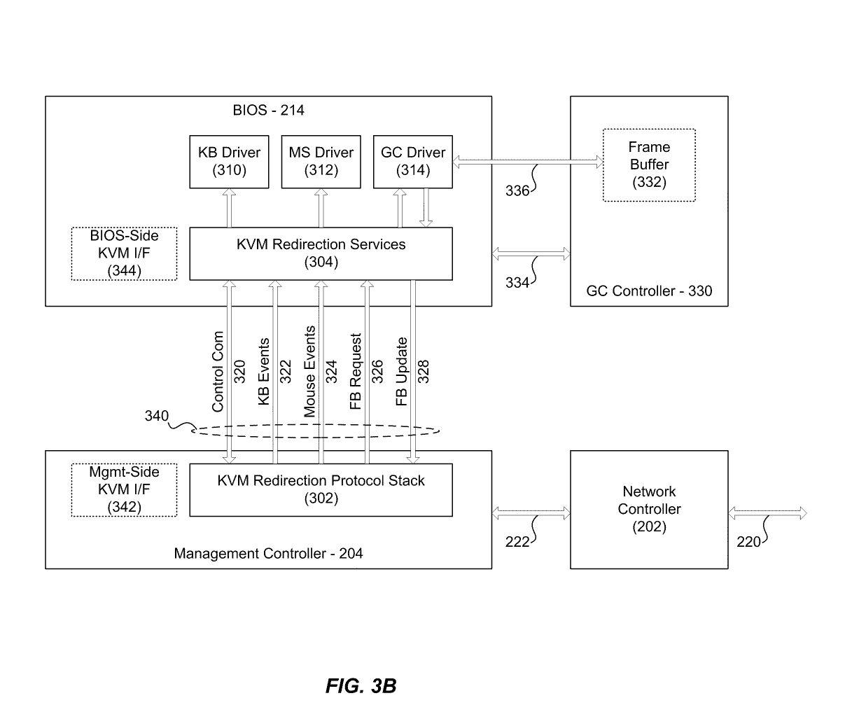

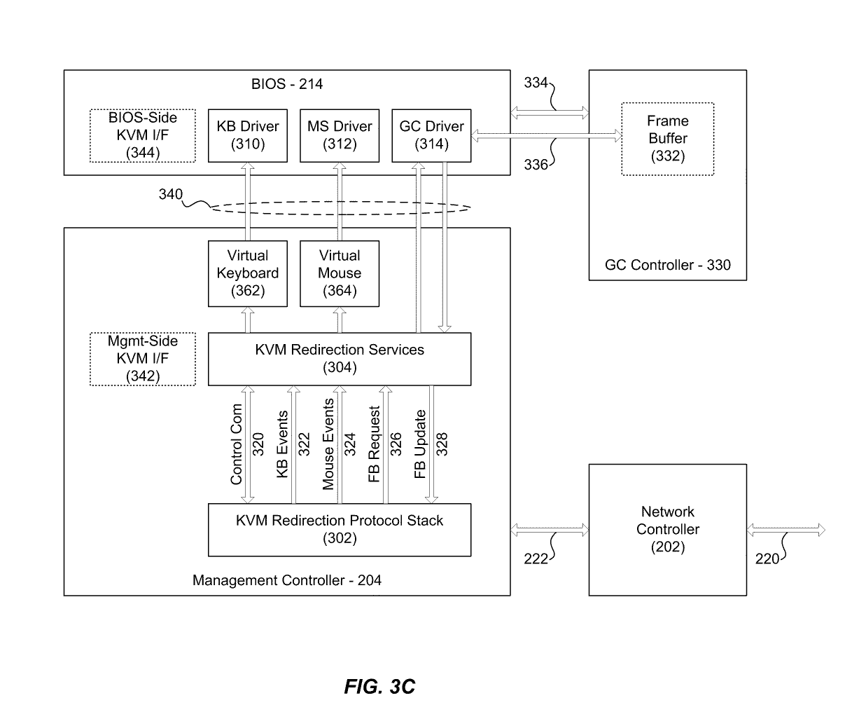

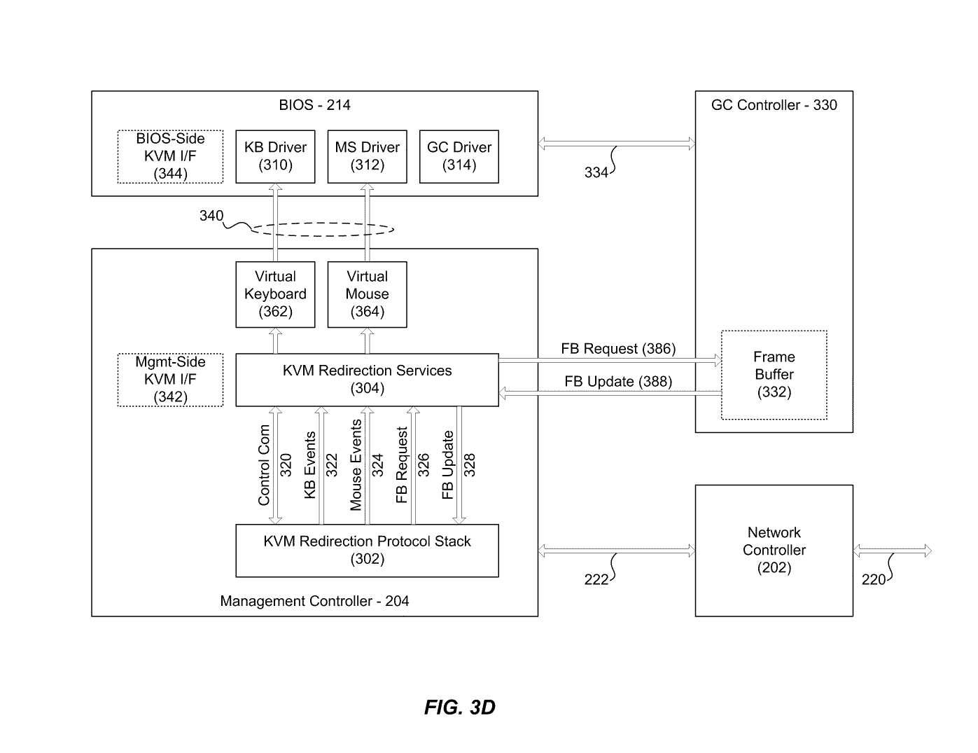

FIG. 3A is a block diagram illustrating exemplary host-independent keyboard, video, and mouse (KVM) redirection via a management controller using system BIOS, with the BIOS providing both KVM services and KVM protocol stack, in accordance with an embodiment of the invention. Referring to FIG. 3A, there is shown the network controller 202, the management controller 204, and the BIOS 214 of the network device 200, substantially as described with regard to FIG. 2. Also shown in FIG. 3A is a graphics controller 330.

The graphics controller 330 may comprise suitable logic, circuitry, interfaces, and/or code that may be operable to generate and/or output images to a display device, such as display 216c. The graphics controller 330 may also be operable to perform additional functions, such as, for example, rendering of 3D graphics, video capture, TV-tuner adapter support, video decoding (e.g. MPEG2 or MPEG4), providing TV output, and/or supporting multiple displays. The graphics controller 330 may be implemented as a dedicated physical component. In this regard, the graphics controller 330 may be a fixed component, and accordingly, it may be integrated into the network device 200, and/or it may be removable, such as a plug-in card, which may be inserted into a PCI-E slot or other bus interface, for example. In some embodiments of the invention, at least portions the graphics controller 330, may also be implemented as software (or firmware) component, and operations described with respect to the graphics controller 330 may be performed by existing physical components of the network device 200. The graphics controller 330 may comprise a frame buffer (FB) 332, which may be utilized during generation and/or outputting of images via the graphics controller 330. In this regard, the FB 332 may comprise suitable logic, circuitry, interfaces, and/or code that may be operable to drive a display device, in accordance with capabilities and/or settings of the display device, based on video data corresponding to frames, which may be read and/or retrieved from a memory buffer.

In operation, the management controller 204 may be utilized to provide and/or support host-independent KVM redirection. In this regard, in instances where the OS 218a, the VMs 218b, and/or the VMM 218c may not be available, such as in pre-OS or post-OS scenarios, the management controller 204 may be operable to handle KVM redirection related messaging communicated to and/or from the network device 200, via the network controller 202. In the embodiment shown in FIG. 3A, the management controller 204 may only be utilized in routing KVM redirection related messaging, with actual KVM redirection related operations and/or handling being provided by other components in the network device 202, such as the BIOS 214 for example. In this regard, use of the BIOS 214 during KVM redirection via the management controller 204 may be done independent of, and/or without necessitating use of the OS 218a, the VMs 218b, and/or the VMM 218c. Rather, the management controller 204 may be operable to interact directly with the BIOS 214, via the management-BIOS interface 308. In this regard, the management-BIOS interface 308 may be provided over existing internal system communication interfaces available in said network device 200, such as over existing system buses utilized during interactions between the management controller 204 and the host 210, or various components thereof including the BIOS 214, which may comprise System Management Bus (SMBus) and/or Peripheral Component Interconnect Express (PCI-E) based buses and/or interconnects. The BIOS 214 may also communicate KVM redirection related messaging directly via the network controller 202, via BIOS-networking interface 306, which may be implemented as part of the interface between the network controller 202 and the host 210 that is utilized for communicating host-network traffic 224.

To support host-independent KVM redirection, the BIOS 214 may comprise a KVM redirection protocol stack component 302 and KVM redirection services component 304. The KVM redirection protocol stack component 302 may be operable to implement one or more KVM redirection protocol stacks corresponding to KVM redirection protocols supported by the network device 200, which may comprise Virtual Network Computing (VNC) based protocols, for example. In this regard, KVM redirection protocols may define mechanisms, sequences, and/or messaging or data structures for use during KVM redirection related interactions between the remote and local KVM peers. The KVM redirection protocols may also define specific mechanisms for performing the necessary KVM actions within the local KVM peer. In this regard, the KVM redirection services component 304 may be operable to perform necessary actions within the network device 200, to perform required KVM redirection operations and/or functions. In this regard, the KVM redirection services component 304 may be invoked and/or triggered by the KVM redirection stack component 302, based on KVM redirection messaging received from the remote KVM peer, such as the remote device 102, which may be routed via the management controller 204. For example, the KVM redirection stack component 302 may utilize control communication 320 to invoke and/or spawn the KVM redirection services component 304 when KVM redirection messaging is initially received, and the KVM redirection stack component 302 and the KVM redirection services component 304 may utilize control communication 320 continually thereafter, such as to perform any necessary status updates.

Furthermore, existing functions and/or components in the BIOS 214, which may normally be utilized during local use of and/or interactions with certain hardware devices, may be utilized to support host-independent KVM redirection. For example, the BIOS 214 may comprise a plurality of device drivers, such as keyboard driver 310, mouse driver 312, and graphics driver 314, which may be utilized in conjunction with local use of the keyboard 216a, mouse 216b, and/or display 216c. In this regard, keyboard driver 310 may be operable to initialize, configure, control, and/or interact with the keyboard 216a of the network device 200. The keyboard driver 310 may be operable, for example, to receive keyboard inputs generated based on use of and/or interactions with the keyboard 216a. These keyboard inputs may be utilized in driving and/or adjusting operations of the network device 200, and/or in interacting with applications run therein, such as any web browser provided via the OS 218a, for example. Similarly, the mouse driver 312 may be operable to initialize, configure, control, and/or interact with the mouse 216b of the network device 200. In this regard, the mouse driver 310 may be operable to receive mouse inputs generated based on use of and/or interactions with the mouse 216b, and/or to facilitate use of these mouse inputs driving and/or adjusting operations of the network device 200, and/or in interacting with applications run therein. The graphics driver 314 may be operable to initialize, configure, control, and/or interact with the display 216c of the network device 200. In this regard, the graphics driver 314 may be interact and/or communicate with the graphics controller 330, over BIOS-graphics interface 334, which may be utilized in the network device 200 to facilitate interactions with and/or use of the display 216c. Accordingly, during host-independent KVM redirection, the keyboard driver 310, the mouse driver 312, and/or the graphics driver 314 may be utilized to support various KVM redirection related operations and/or functions.

For keyboard redirection, the KVM redirection protocol stack component 302 may generate based on KVM redirection messaging received from the remote KVM peer, such as the remote device 102, keyboard events 322, which may be sent to the KVM redirection services component 304. The keyboard events 322 may resemble local keyboard inputs, which may normally be generated based on user interactions with the keyboard 216a. Accordingly, the KVM redirection services component 304 may perform the remote keyboard actions specified in the keyboard events 322, by utilizing the keyboard driver 310 of the BIOS 214 for example. Similarly, for mouse redirection, the KVM redirection stack component 302 may generate based on KVM redirection messaging received from the remote KVM peer, such as the remote device 102, mouse events 324, which may be sent to the KVM redirection services component 304. The mouse events 324 may be similar to local mouse inputs, which may normally be generated based on user interactions with the mouse 216b. Accordingly, the KVM redirection services component 304 may perform the remote mouse actions specified in the mouse events 324, by utilizing the mouse driver 312 of the BIOS 214 for example.

For video redirection, the KVM redirection stack component 302 may trigger based on KVM redirection messaging received from the remote KVM peer, generating and/or retrieving of graphics related data via the KVM redirection services component 304. In this regard, the KVM redirection services component 304 may utilize the graphics driver 314, to perform graphics related interactions which may resemble local graphics related operations in the network device 200, such as when using the display 216c. For example, the graphics driver 314 may be utilized to interact with the graphics controller 330, to enable generating and/or retrieving graphics related data that may then be communicated back to the remote KVM redirection peer. In this regard, the graphics driver 314 may utilize frame buffer (FB) access 336, using the BIOS-graphics interface 334, to retrieve graphics related data directly from the frame buffer (FB) 332 in the graphics controller 330. In an embodiment of the invention, graphics redirection may be provided in the network device 200 based on a graphics redirection messaging interface (GRMI). Use of the GRMI interface may enable exposing various graphics related functions, by defining messaging semantics and/or structures for use in conjunction with these functions. For example, frame buffer (FB) requests 326, and/or responses thereto, may be utilized for request and/or receive contents of the frame buffer 332; and frame buffer (FB) updates 328 may be utilized to provide, without request from the remote peer, updates as to the contents of the frame buffer 332. The GRMI interface may also comprise display format related messaging, which may be utilized in to get and/or set such display related setting as pixel format and/or color mapping.

FIG. 3B is a block diagram illustrating exemplary host-independent keyboard, video, and mouse (KVM) redirection via a management controller using system BIOS, with the BIOS providing only KVM services, in accordance with an embodiment of the invention. Referring to FIG. 3B, there is shown the network controller 202, the management controller 204, the BIOS 214, and graphics controller 330 of the network device 200.

In operation, the management controller 204 may provide host-independent KVM redirection substantially as described with regard to FIG. 3A. In the embodiment shown in FIG. 3B, however, the management controller 204 may be utilized more actively during host-independent KVM redirection compared to FIG. 3A, by being directly utilized to implement and/or perform KVM redirection related operations and/or functions. In this regard, the KVM redirection protocol stack component 302 and KVM redirection services component 304 may be split between the management controller 204 and the BIOS 214, with the KVM redirection protocol stack component 302 residing and/or being implemented in the management controller 204 while the KVM redirection services component 304 residing and/or being implemented in the BIOS 214. Accordingly, interactions between the KVM redirection protocol stack component 302 and KVM redirection services component 304 during host-independent KVM redirection, as described with respect to FIG. 3A, may be performed over the management-BIOS interface 308.

In this regard, a particular KVM redirection interface 340 may be utilized to enable interactions between the management controller 204 and the BIOS 214 over the management-BIOS interface 308 during host-independent KVM redirection operations. Furthermore the KVM redirection interface 340 may enable performing these interactions uniformly, regardless of the type of buses and/or interconnects utilized for BIOS-management communications. For example, the various interactions between the KVM redirection stack component 302 and the KVM redirection services component 304, substantially as described with regard to FIG. 3A, may now be performed over the KVM redirection interface 340. To support use of the KVM redirection interface 340, the management controller 204 and the BIOS 214 may comprise corresponding components, management-side KVM I/F component 342 and BIOS-side KVM I/F component 344, respectively, for handling communication over the KVM redirection interface 340. In this regard, each of the management-side KVM I/F component 342 and BIOS-side KVM I/F component 344 may comprise suitable logic, circuitry, interfaces, and/or code that may be operable to process, format, and/or encapsulate internal KVM redirection related messaging based on the type of the underlying interconnects or buses over which the KVM redirection interface 340 may be established. For example, in instances where the management-BIOS interface 308, over which the KVM redirection interface 340 is established, comprises a PCI-E interface, the management-side KVM I/F component 342 and BIOS-side KVM I/F component 344 may be operable to format and/or encapsulate internal KVM redirection related messaging, such as control communication 320, keyboard events 322, mouse events 324, FB requests 326, and/or FB updates, as PCI-E based communication.

Accordingly, the management controller 204 may handle, via the KVM redirection protocol stack component 302, KVM redirection messaging and/or communication with the remote KVM redirection peers, and may invoke and/or trigger specific KVM redirection related functions and/or operations in the BIOS 214, via interactions with the KVM redirection services component 304. For example, the KVM redirection protocol stack component 302 in the management controller 204 may generate keyboard events 322 and/or mouse events 324, and may communicate them over the KVM redirection interface 340 to the KVM redirection services component 304 in the BIOS 214. The KVM redirection services component 304 may then utilize the event messages to trigger local keyboard and/or mouse actions, substantially as described with regard to FIG. 3A for example. Similarly, graphics related redirection may be performed based on interactions between the KVM redirection protocol stack component 302 in the management controller 204 and the KVM redirection services component 304 in the BIOS 214 over the KVM redirection interface 340, with the KVM redirection services component 304 in the BIOS 214 performing the necessary graphics related functions, including interactions with the graphics controller 330 and/or the frame buffer (FB) 332 thereof, substantially as described with regard to FIG. 3A.

FIG. 3C is a block diagram illustrating exemplary host-independent keyboard, video, and mouse (KVM) redirection via a management controller using system BIOS, with the management controller providing both KVM services and KVM stack, in accordance with an embodiment of the invention. Referring to FIG. 3C, there is shown the network controller 202, the management controller 204, the BIOS 214, and graphics controller 330 of the network device 200.

In operation, the management controller 204 may support providing host-independent KVM redirection, substantially as described with regard to FIG. 3B. In the embodiment shown in FIG. 3C, however, more of the KVM redirection related functions and/or operations may be shifted to the management controller 204, to reduce use and/or involvement of other components in the network device 200, such as the BIOS 214. In this regard, both of the KVM redirection protocol stack component 302 and KVM redirection services component 304 may reside and/or be implemented in the management controller 204. Accordingly, the management controller 204 may be operable to handle both KVM redirection related messaging and/or interactions between the network device 200 and remote KVM redirection peers, and invocation of KVM redirection related services that may be required to performed requested KVM redirection operations. The KVM redirection interface 340 may also be utilized to enable interactions between the management controller 204 and the BIOS 214 over the management-BIOS interface 308, during host-independent KVM redirection operations. However, the KVM redirection interface 340 may now be utilized to facilitate interactions between the KVM redirection services, and/or related functions, running in the management device 204 and particular components in the BIOS 214 that may be pertinent to KVM redirection operations, such as the keyboard driver 310, the mouse driver 312, and/or the graphics driver 314.

For example, for keyboard redirection, the KVM redirection stack component 302 in the management controller 204 may generate based on KVM redirection messaging received from the remote KVM peers, keyboard events 322 and/or mouse events 324. The generated keyboard events 322 and/or mouse events 324 may then be forward to the KVM redirection services component 304 in the management controller 204. The KVM redirection services component 304 may utilize the event messages to trigger corresponding local keyboard and/or mouse actions, by utilizing and/or communicating with the BIOS 214 for example. In this regard, the KVM redirection services component 304 may interact with the keyboard driver 310 in the BIOS 214, via the KVM redirection interface 340, to enable simulating local keyboard actions and/or events based on the keyboard events 322 by utilizing keyboard related functions available via the keyboard driver 310. For mouse redirection, the KVM redirection services component 304 may interact with the mouse driver 312 in the BIOS 214, via the KVM redirection interface 340, to enable simulating local mouse actions and/or events based on the mouse events 324 by utilizing mouse related functions available via the mouse driver 312.

In an embodiment of the invention, the management controller 204 may be operable to spawn and/or utilize virtual keyboard function 362 and/or virtual mouse function 364, which may be as intermediaries between the components during keyboard and the KVM redirection stack component 302 in the management controller 204 and the keyboard driver 310 and/or the mouse driver 312 in the BIOS 214. In this regard, virtual keyboard function 362 and/or virtual mouse function 364 may be operable to utilize the keyboard events 322 and/or the mouse events 324, respectively, to generate what appears like local keyboard and/or mouse inputs, which may then be communicated directly to the keyboard driver 310 and/or the mouse driver 312 in the BIOS 214 over the KVM redirection interface 340.

For video redirection, the KVM redirection services component 304 may interact with the graphics driver 314 in the BIOS 214, via the KVM redirection interface 340, to enable generating and/or obtaining local graphics data, which may then be communicated, via the KVM redirection stack component 302 to remote KVM redirection peers. In this regard, the graphics driver 310 may perform the actual interactions with the graphics controller 330 and/or the frame buffer (FB) 332 thereof, substantially as described with regard to FIG. 3A. This may enable obtaining the content of the frame buffer (FB) 332, either based on FB request/response 326 based messaging and/or FB update 328 based messaging, in accordance with the graphics redirection messaging interface (GRMI).

The KVM redirection interface 340 may be configured to enable interactions between the management controller 204 and the BIOS 214 during host-independent KVM redirection operations to support the split between the KVM redirection services component 304 in the management controller 204 and the pertinent device drivers in the BIOS 214. In this regard, the management-side KVM I/F component 342 and the BIOS-side KVM I/F component 344 may be configured to enable generating, processing, and/or handling of internal KVM redirection related messaging for invoking particular components in the BIOS 214 by the KVM redirection services component 304 in the management controller 204 regardless of the type of the underlying interconnects or buses over which the KVM redirection interface 340 may be established. For example, in instances where the management-BIOS interface 308, over which the KVM redirection interface 340 is established, comprises a PCI-E interface, the management-side KVM I/F component 342 and BIOS-side KVM I/F component 344 may be operable to format and/or encapsulate as PCI-E based communication internal KVM redirection related messaging, corresponding to keyboard, mouse, and/or graphics related interactions with the keyboard driver 310, the mouse 312, and/or the graphics controller 314.

FIG. 3D is a block diagram illustrating exemplary host-independent keyboard, video, and mouse (KVM) redirection via a management controller using system BIOS, with the management controller providing both KVM services and KVM stack and interacting directly with graphic controllers, in accordance with an embodiment of the invention. Referring to FIG. 3C, there is shown the network controller 202, the management controller 204, the BIOS 214, and graphics controller 330 of the network device 200.

In the embodiment shown in FIG. 3D, the management controller 204 may be utilized to provide and/or support host-independent KVM redirection with both of the KVM redirection stack component 302 and KVM redirection services component 304 residing and/or being implemented in the management controller 204, substantially as described with regard to FIG. 3C. Additionally, for video redirection, the KVM redirection services component 304 may also be operable to interact directly with the graphics controller 330, without requiring use of the BIOS 214 or the graphics driver 310, when generating and/or obtaining local graphics data, which may then be communicated, via the KVM redirection protocol stack component 302 to remote KVM redirection peers. In this regard, the KVM redirection services component 304 in the management controller 204 may perform the actual interactions with the graphics controller 330 and/or the frame buffer (FB) 332 thereof, substantially as described with regard to FIG. 3A, in accordance with the graphics redirection messaging interface (GRMI) for example. The KVM redirection services component 304 may be operable to support frame buffer (FB) access operations, for example, to obtain or acquire content of the frame buffer (FB) 332, based on exchange of FB requests 386, and corresponding responses thereto, and/or based on reception of FB updates 388. The FB access by the KVM redirection services component 304 in the management controller may be done over existing and/or available system buses and/or interconnects, or interfaces pertaining thereto, between the management controller 204 and the graphics controller 330. These may comprise SMBus based bus and/or interconnects which may typically be utilized during management operations.

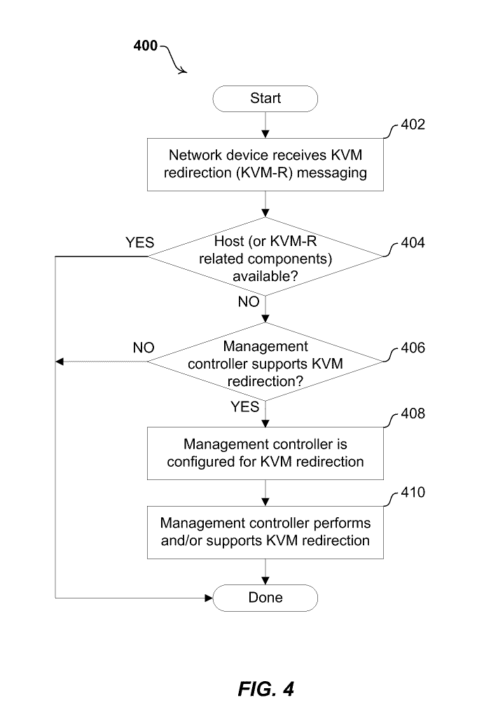

FIG. 4 is a flow chart that illustrates exemplary steps for host independent keyboard, video, and mouse (KVM) redirection, in accordance with an embodiment of the invention. Referring to FIG. 4, there is shown a flow chart 400 comprising a plurality of exemplary steps that may be performed to enable performing host independent keyboard, video, and mouse (KVM) redirection during networking.

In step 402, a network device, such as the network device 200, may receive KVM redirection messaging from a remote KVM redirection peer, such as the remote device 102. In step 404, it may be determined whether the host environment in the network device, such as host 210 in the network device 200, and/or components thereof which are particularly utilized during KVM redirection are available. In instances where it may be determined that the host, and/or KVM redirection related components are available, the plurality of exemplary steps may terminate as the KVM redirection may be handled directly by the host.

Returning to step 404, in instances where it may be determined that the host, and/or KVM redirection related components are not available, the plurality of exemplary steps may proceed to step 406. In step 406, it may be determined whether the management controller in the network device may be operable to perform and/or supports KVM redirection. In instances where it is determined that the management controller is not capable of performing and/or supporting the requested KVM redirection, the plurality of exemplary steps may terminate.

Returning to step 406, in instances where the management controller is determined to be able to perform and/or support KVM redirection, the plurality of exemplary steps may proceed to step 408. In step 408, the management controller may be configured for KVM redirection. In step 410, the management controller performs and/or supports KVM redirection.

Various embodiments of the invention may comprise a method and system for host independent keyboard, video, and mouse (KVM) redirection. The management controller 204 of the network device 200 may provide and/or support host-independent keyboard, video, and mouse (KVM) redirection operations in the network device 200. In this regard, the management controller 204 may support and/or perform KVM redirection independent of availability and/or operations of host 210 of the network device 200, and/or components thereof, such as OS 218a, VMs 218b, and/or VMM 218c. The management controller 204 may provide host-independent KVM redirection in pre-OS and/or post-OS scenarios for example. The management controller 204 may be operable to route, during host-independent KVM redirection operations, KVM redirection related interactions and/or messaging between the network device 200 and remote KVM redirection peers, such as remote device 102. The handling of KVM redirection related functions and/or operations may be performed and/or provided by other components in the network device 200, such as via the BIOS 214 and/or the graphics controller 330. In this regard, during host-independent KVM redirection, the management controller 204 may utilize keyboard driver 310, mouse driver 312, and/or graphics driver 314 in the BIOS 214 of the network device 200.

KVM redirection protocol stack 302 may be implemented in the network device 200 to support KVM redirection, including host-independent KVM redirection, by enabling establishing and/or performing peer-to-peer KVM redirection connectivity and/or communications, and/or invoking of KVM redirection services 304 in the network device 200. The KVM redirection protocol stack 302 may be implemented in the BIOS 214, and the BIOS 214 may also provide and/or perform at least a portion of the corresponding KVM redirection services 304. The management controller 204 may also implement at least a portion of the KVM redirection protocol stack 302, and/or may also directly provide and/or perform at least a portion of the KVM redirection services 304. During management controller 204 supported host-independent KVM redirection, the management controller 204 may exchange KVM redirection related messages and/or data with other components of the network device 200, such as the BIOS 214 and/or the graphics controller 330. In this regard, the KVM redirection related messages and/or data may be communicated via KVM redirection interface 340, which may be established over existing internal system communication interfaces available in the network device 200, such as Peripheral Component Interconnect Express (PCI-E) and/or System Management Bus (SMBus) based system buses or interconnects.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for host independent keyboard, video, and mouse (KVM) redirection.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
handling by a management controller in a network device, at least a portion of keyboard, video, and mouse (KVM) redirection in said network device, wherein said management controller is operable to provide said at least portion of KVM redirection independent of operations of said network device.

2. The method according to claim 1, comprising handling said at least a portion of KVM redirection by said management controller independent of operating system (OS), basic input/output system (BIOS), virtualization related components, and/or graphics operations in said network device.

3. The method according to claim 1, comprising routing KVM redirection related interactions with remote KVM peers via said management controller during said handling of said at least a portion of KVM redirection.

4. The method according to claim 1, wherein at least a portion of KVM protocol stack is implemented in said management controller, wherein said KVM protocol stack is utilized to provide peer-to-peer KVM redirection connectivity and/or communications, and/or to invoke KVM services in said network device.

5. The method according to claim 4, comprising performing at least a portion of said KVM services directly via said management controller.

6. The method according to claim 5, comprising handling KVM redirection related keyboard and/or mouse events by said at least portion of KVM services performed directly via said management controller, wherein said handling comprises utilizing keyboard driver and/or mouse driver of basic input/output system (BIOS) of said network device.

7. The method according to claim 5, comprising handling KVM redirection related graphics operations by said at least portion of KVM services performed directly via said management controller, wherein said handling comprises interacting directly with a graphics controller of said network device.

8. The method according to claim 1, comprising exchanging KVM related messages and/or data with other components of said network device during said handling of said at least a portion of KVM redirection.

9. The method according to claim 8, comprising communicating said KVM related messages and/or data over existing internal system communication interfaces available in said network device.

10. The method according to claim 9, wherein said internal system communication interfaces comprises one or more of Peripheral Component Interconnect Express (PCI-E) or System Management Bus (SMBus) based system buses or interconnects.

11. A system comprising:
one or more circuits for use in a management controller of a network device, said one or more circuits being operable to handle at least a portion of keyboard, video, and mouse (KVM) redirection in said network device, wherein said management controller is operable to provide said at least portion of KVM redirection independent of operations of said network device.

12. The system according to claim 11, wherein said one or more circuits are operable to handle said at least a portion of KVM redirection by said management controller independent of operating system (OS), basic input/output system (BIOS), virtualization related components, and/or graphics operations in said network device.

13. The system according to claim 11, wherein said one or more circuits are operable to route KVM redirection related interactions with remote KVM peers via said management controller during said handling of said at least a portion of KVM redirection.

14. The system according to claim 11, wherein at least a portion of KVM protocol stack is implemented in said management controller, wherein said KVM protocol stack is utilized to provide peer-to-peer KVM redirection connectivity and/or communications, and/or to invoke KVM services in said network device.

15. The system according to claim 14, wherein said one or more circuits are operable to perform at least a portion of said KVM services directly via said management controller.

16. The system according to claim 15, wherein said one or more circuits are operable to handle KVM redirection related keyboard and/or mouse events by said at least portion of KVM services performed directly via said management controller, wherein said handling comprises utilizing keyboard driver and/or mouse driver of basic input/output system (BIOS) of said network device.

17. The system according to claim 15, wherein said one or more circuits are operable to handle KVM redirection related graphics operations by said at least portion of KVM services performed directly via said management controller, wherein said handling comprises interacting directly with a graphics controller of said network device.

18. The system according to claim 11, wherein said one or more circuits are operable to exchange KVM related messages and/or data with other components of said network device during said handling of said at least a portion of KVM redirection.

19. The system according to claim 18, wherein said one or more circuits are operable to communicate said KVM related messages and/or data over existing internal system communication interfaces available in said network device.

20. The system according to claim 19, wherein said internal system communication interfaces comprises one or more of Peripheral Component Interconnect Express (PCI-E) or System Management Bus (SMBus) based system buses or interconnects.
